(19) United States
(12) Patent Application Publication
(10) Pub. No.: US 2017/0265477 A1
(43) Pub. Date: Sep. 21, 2017

(54) Aqueous Adjuvant Composition Containing Glufosinate

(71) Applicant: Clariant International Ltd., Muttenz (CH)

(72) Inventors: Peter BAUR, Schondorf (DE); Martin BAUER, Frankfurt am Main (DE); Gerd SCHWEINITZER, Frankfurt am Main (DE); Stefanie WOLF, Frankfurt am Main (DE)

(73) Assignee: Clariant International Ltd., Muttenz (CH)

(21) Appl. No.: 15/515,324

(22) PCT Filed: Sep. 29, 2015
(86) PCT No.: PCT/EP2015/072453

§ 371 Date: Mar. 29, 2017

(30) Foreign Application Priority Data
Sep. 30, 2014 (DE) 102014014124.1
Oct. 23, 2014 (DE) 202014008420.3

(51) Int. Cl. A01N 57/20; A01N 37/40; A01N 47/28; A01N 37/20; A01N 31/02

(52) U.S. Cl. CPC A01N 57/20; A01N 37/20; A01N 31/02; A01N 47/28; A01N 37/40

(57) ABSTRACT

The invention relates to a composition comprising
a) the active agrochemical ingredient glufosinate,
b) optionally one or more further active agrochemical ingredients,
c) one or more N-alkylglucamides of the formula (I)

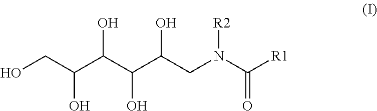

where
R1 is a linear or branched alkyl group having 5 to 9 carbon atoms, and
R2 is an alkyl group having 1 to 3 carbon atoms,
d) one or more di- or trihydric alcohol cosolvents,
e) optionally one or more nitrogen-containing salts and/or urea,
f) optionally one or more surfactants,
g) optionally one or more further customary formulating assistants, and
h) water.

The compositions of the invention are low-foaming aqueous formulations of active agrochemical ingredients which are of high activity, which are distinguished by a very advantageous toxicological and environmental profile, and which exhibit high storage stability in conjunction with uniform and high biological activity.

The invention pertains to the technical field of the compositions (preparations or formulations) for active agrochemical ingredients, such as pesticides in the crop protection field. Described specifically are aqueous, storage-stable active ingredient preparations and, very particularly, formulations of (partially) water-soluble active agrochemical ingredients, more particularly formulations of saltlike active agrochemical ingredients, very particularly of glufosinate salts such as glufosinate ammonium salt, which also has the ISO name glufosinate-ammonium.

The invention further pertains to mixtures of adjuvants which can be used in combination with the stated active agrochemical ingredients and their formulations.

Pesticides (especially fungicides, herbicides, and insecticides) are chemical or natural substances which penetrate plant cells, plant tissue or parasitic organisms in or on the plant, subjecting them to damage and/or destruction. The largest cohort of pesticides is represented by herbicides. Pesticides are used customarily in the form of liquid or solid concentrated preparations (formulations), which facilitate handling for the user or ensure a greater activity on the part of the active ingredient. Prior to use, the formulations are customarily diluted with water and then delivered by spray application.

Water-soluble concentrates (soluble liquids, abbreviated to SL) are one particularly important form of pesticide preparations. They play a major role in particular with herbicides, and the pesticides are often used in the form of water-soluble salts, being converted into their alkali metal salts or ammonium salts by neutralization of the acid form of the herbicides with suitable bases.

A particularly important part is played by the water-soluble salts of herbicides, such as, for example, of glyphosate, of glufosinate or of the auxin herbicides such as 2,4-D or dicamba. They are used preferably as alkali metal salts or in the form of various ammonium salts, or as a mixture of these salts, generally as aqueous formulations.

A general problem affecting the application of active agrochemical ingredients is that only a fraction of the active ingredient develops the desired activity. The greatest part by far is lost without being utilized, with the active ingredient failing to reach the leaves or roots of the plant when the spray mixture is delivered, and instead seeping unused into the soil, being washed off by rain, or simply not being taken up by the plant.

This environmental and economic disadvantage can be reduced by addition of auxiliaries (adjuvants) to active ingredient formulations. These auxiliaries are able, for example, to improve wetting of the plant or to ensure that the active ingredient adheres for longer to the plant surface or is taken up more effectively. Particularly in the case of water-soluble active ingredients, such as glufosinate, for example, the nature and the amount of the adjuvants used have a critical influence on the activity of the formulation.

The requirements made of suitable adjuvants for active ingredient preparations have grown continually over the years. As well as high biological activity and unobjectionability, from the standpoint both of the user and of the environment, there is increasing demand for more advantageous performance properties. In order to be able to further boost the uptake of systemic active ingredients, such as glufosinate-ammonium, other desirable properties of a suitable adjuvant are the requirement of wetting, solubilization, and capacity for combination with ammonium sulfate and active electrolyte ingredients, and also excellent plant tolerance. The adjuvants are to maximize the loading of the formulation with the active ingredient, and are as far as possible to be compatible with different active ingredients. The formulations must be storage-stable and exhibit an extremely low viscosity, in order to ensure greater ease of handling, and to facilitate complete discharge from the container as far as possible. Other requirements are good miscibility and rapid dissolution, including and especially in cold water, when the spray mixture is prepared. Moreover, the formulations are required to exhibit low foaming behavior on dilution with water before application and on spraying during application.

Aqueous formulations of glufosinate-ammonium are known from EP-A-0048436, EP-A-0336151, EP-A-1093722 or WO 2007/147500 A1, for example. Here, alkyl ether sulfates are used with preference. Standard commercial formulations use alkyl ether sulfate adjuvants with alkyl chain lengths of C₁₂-C_{16,} with 1 to 10 ethyleneoxy units. These adjuvants are capable of boosting the biological activity of glufosinate on application to the green parts of plants. The precise mechanism of action of the alkyl ether sulfates here is unknown. The peculiar suitability of alkyl ether sulfates for activity boosting in glufosinate lies in a combination of favorable properties on the part of the alkyl ether sulfates. Other adjuvants having comparable surfactant properties (such as, for example, spray mist adhesion or spreading on target plants), including all of the herbicide adjuvants described in the “Compendium of Herbicide adjuvants” (www. herbicide-adjuvants.com, 2014), lead to diminished activity relative to the stated alkyl ether sulfates. Even substances with solvent character, such as polyether glycols, glycerol, mineral oils, mineral oil concentrates, polymers, buffers, and other substances, do not feature a comparable effect. Certain nonionic surfactants which are used in standard commercial formulations (Liberty®, from Bayer, EPA Reg. No. 264-829) are sugar-based alkylpolyglycosides. They are used, however, only in combination with the aforementioned alkyl ether sulfates, in order to prevent a diminished effect on the part of the glufosinate formulation.

On account of the C₁₂-C₁₆ alkyl ether sulfates of the stated type that are included in the standard commercial glufosinate formulations, the formulations exhibit unfavorable foaming behavior on dilution with water before application and on spraying during application, unless defoamers are added. The consequences then are often overflow of the spraying apparatus, contamination of the environment, irregular spray deposits on the plants, and residues of crop protection materials in the spraying apparatus.

According to EP-A-0407874, effective defoamers from the group of the perfluoroalkylphosphinic acids or -alkylphosphonic acids were proposed for aqueous liquid crop protection materials. Such defoamers are notable for a high defoamer effect for a comparatively low application rate, with the defoamer effect remaining stable even on prolonged storage at different temperatures and with the formulations subject to mechanical stress. Furthermore, the biological activity of the formulated crop protection materials is unaffected by the presence of defoamer.

In view of ecotoxicological considerations, in order to reduce the spread of fluorine-containing hydrocarbons in the environment, fluorinated defoamers are no longer being used, and are being replaced by defoamers having a better ecotoxicological profile, such as, for example, defoamers from the group of the fatty acid alkyl ester alkoxylates, organopolysiloxanes such as polydimethylsiloxanes and mixtures thereof with microfine, optionally silanized silica, paraffins, waxes, and microcrystalline waxes, and mixtures thereof with silanized silica. The activity of unfluorinated defoamers for glufosinate-ammonium formulations with the adjuvant C₁₂-C₁₆ alkyl ether sulfate, however, is not always adequate. With many such formulations, for example, the defoaming effect is dependent on the degree of hardness of the water (the amount of calcium salts and magnesium salts therein) which is used for preparing the spray mixtures, or it is not possible to achieve a homogeneous formulation.

In addition to the unfavorable foaming behavior, other disadvantageous properties are known for standard commercial glufosinate formulations containing C₁₂-C₁₆ alkyl ether sulfates.

From an economic standpoint, maximum active substance loading levels are desirable for crop protection formulations. The maximum active ingredient loading level for aqueous formulations of glufosinate-ammonium when using the aforementioned C₁₂-C₁₆ alkyl ether sulfate adjuvant, however, is limited to <300 g/l a. e.

For improvement in activity of crop protection materials, moreover, efforts are being made to incorporate water-soluble fertilizers and/or plant nutrients, such as ammonium sulfate (AMS) or urea, into formulations. For aqueous formulations of glufosinate-ammonium using the aforementioned C₁₂-C₁₆ alkyl ether sulfate as adjuvant, the incorporation of water-soluble fertilizer and/or of plant nutrients, such as ammonium sulfate (AMS) or urea, results in phase separation.

It is known that the abovementioned C₁₂-C₁₆ alkyl ether sulfates have an antagonistic effect on the activity of other herbicides such as glyphosate, for example. Therefore, standard commercial glufosinate formulations which contain C₁₂-C₁₆ alkyl ether sulfates cannot be combined with glyphosate formulations in the spray mixture.

For the reasons given there is a need for alternative solutions which permit the production of highly loaded, low-foaming aqueous formulations with glufosinate and which permit combinability with other agrochemical, water-soluble active ingredients, these formulations being highly active, being notable for very advantageous toxicological and environmental profiles, and promoting an increase in the uptake of systemic active ingredients, wetting, and solubilization, and allowing combinability with ammonium sulfate and other (active) electrolyte ingredients, and having the properties that are advantageous from an applications standpoint, such as, for example, good storage stability and uniform and high biological activity. It would therefore be ideal to use nonionic surfactants as adjuvants for glufosinate formulations in order to rule out the antagonisms associated with the anionic alkyl ether sulfates.

A suitable nonionic class of surfactants with similar combination of properties to alkyl ether sulfates is that of sugar-based surfactants, such as alkyl-N-methylglucosamides.

The use of sugar-based surfactants, such as alkyl-N-methylglucosamides, in cleaning products and cosmetic products, for example, is described in the literature (F.W. Lichtenthaler, “Carbohydrates as Organic Raw Materials” in Ullmann's Ullmann's Encyclopedia of Industrial Chemistry, Wiley-VCH Verlag, 2010).

WO-A-96/16540 describes pesticide compositions which long-chain alkylamides which carry a polyhydroxycarbonyl substituent having at least three hydroxyl groups on the amide nitrogen. The examples describe emulsifiable concentrates, water-dispersible powders, and granules of dodecyl-N-methylglucamide, dodecyltetradecyl-N-methylglucamide, and cetylstearyl-N-methylglucamide.

Surprisingly, the demand described above for alternative solutions is met very effectively by the alkyl-N-alkylglucosamide-based compositions that are described hereinafter.

Known from DE 10 2012 021 647 A1 are aqueous adjuvant compositions which comprise one or more alkylglucamides of the formula (I) described below, water, and optionally a cosolvent. These adjuvants are used in aqueous pesticide preparations and are distinguished by high activity and also by a very advantageous toxicological and environmental profile. Features stated are the high salt stability, the phase stability at high and low temperatures, and the possibility of providing formulations with a high pesticide concentration. The examples describe formulations with glyphosate, with 2,4-D, or with combinations of 2,4-D and glyphosate. The general description mentions glufosinate as a pesticide among numerous pesticides. Also mentioned in the description is the combination of at least two water-soluble pesticides, such as glyphosate, glufosinate, 2,4-D, dicamba or fomesafen.

In the production of aqueous glufosinate formulations with N-alkylglucamides it has emerged that sufficient phase stability can be achieved only if as well as water there is a selected cosolvent present in sufficient amount. Under those conditions it is possible to provide storage-stable formulations having surprisingly high pesticide concentrations.

The invention relates to compositions comprising
a) the active agrochemical ingredient glufosinate,
b) optionally one or more further active agrochemical ingredients,
c) one or more N-alkylglucamides of the formula (I)

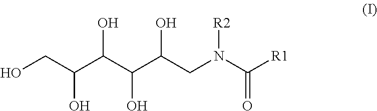

where
R1 is a linear or branched alkyl group having 5 to 9 carbon atoms, and
R2 is an alkyl group having 1 to 3 carbon atoms,
d) one or more cosolvents selected from the group of di-or trihydric alcohols,
e) optionally one or more nitrogen-containing salts and/or urea,
f) optionally one or more surfactants,
g) optionally one or more further customary formulating assistants, and
h) water.

With particular preference the active agrochemical ingredient glufosinate of component a) comprises water-soluble salts of glufosinate, and especially preferably comprises glufosinate-ammonium.

“Active agrochemical ingredients” for the purposes of the present invention are pesticides, such as acaricides, bactericides, fungicides, herbicides, insecticides, molluscides, nematicides, and rodenticides, and also phytohormones, such as plant growth regulators, and safeners. Phytohormones govern physiological responses, such as growth, flowering rhythm, cell division, and seed maturation. An overview of the most relevant pesticides is found for example in “The Pesticide Manual” from the British Crop Protection Council, 16th Edition 2012, Editor: C. MacBean. The active ingredients listed therein are hereby expressly referenced. They are deemed by reference to be part of the present description.

The one or more further active agrochemical ingredients optionally present as component b) in the compositions of the invention are preferably selected from the group consisting of fungicides, herbicides, insecticides, or are preferably safeners or plant growth regulators, or combinations of two or more of these active ingredients. Water-soluble active agrochemical ingredients are preferred. Particularly preferred are pesticides, among them more particularly the water-soluble salts of pesticides, and most preferably the herbicides, among them more particularly the water-soluble salts of herbicides.

In a further preferred embodiment, the further water-soluble pesticides of component b) are not herbicides, being for example insecticides from the group of the chloronicotinyls, such as thiamethoxam, or growth regulators, such as chlormequat chloride.

Water-soluble active agrochemical ingredients, pesticides, herbicides or insecticides in the sense of the invention are active agrochemical ingredients, pesticides, herbicides or insecticides which at room temperature (25° C.) have a solubility in water of more than 5 wt % and preferably more than 10 wt % in water.

Particularly preferred water-soluble pesticides are the water-soluble herbicides, and preferred among them in turn are the water-soluble salts of acifluorfen, aminopyralid, amitrole, asulam, benazolin, bentazone, bialaphos, bispyribac, bromacil, bromoxynil, bicyclopyrone, chloramben, clopyralid, 2,4-D, 2,4-DB, dicamba, dichlorprop, difenzoquat, diquat, endothal, fenoxaprop, flamprop, flumiclorac, fluoroglycofen, fomesafen, fosamine, glyphosate, imizameth, imazamethabenz, imazamox, imazapic, imazapyr, imazaquin, imazethapyr, MCPA, MCPB, mecoprop, octanoic acid, paraquat, pelargonic acid, picloram, quizalofop, 2,3,6-TBA, and triclopyr.

Preferred among the water-soluble salts of active agrochemical ingredients, more particularly of pesticides, are, in particular, the alkali metal salts and ammonium salts, and of these in turn the potassium, ammonium, dimethylammonium, isopropylammonium, diglycolammonium, and (2-hydroxyethyl)trimethylammonium salts.

The precise chemical composition and structure of all of these compounds are known and can be looked up on the Internet at: http://www.alanwood.net/pesticides/index_cn_frame.html

The compositions of the invention in the form of concentrates preferably comprise 1 to 40 wt %, more preferably 10 to 35 wt %, more particularly 15 to 30 wt %, of the active agrochemical ingredient glufosinate as component a). The quantity figures here are based on the total weight of the composition. The amounts of component a) may of course be lowered correspondingly by dilution prior to application.

The compositions of the invention in the form of concentrates preferably comprise 1 to 40 wt %, more preferably 2 to 30 wt %, especially preferably 5 to 20 wt % of the one or more further active agrochemical ingredients as component b). The quantity figures here are based on the total weight of the composition. The amounts of component b) may of course be lowered correspondingly by dilution prior to application.

With particular preference the compositions of the invention comprise 18 to 40 wt % and preferably 25 to 40 wt % of the active agrochemical ingredient glufosinate of component a) and no further active agrochemical ingredients of component b).

In another particularly preferred embodiment, the compositions of the invention comprise 15 to 30 wt % of the active agrochemical ingredient glufosinate of component a) and 15 to 30 wt % of one or more further active agrochemical ingredients of component b).

The further active agrochemical ingredients b) optionally present are preferably pesticides, especially preferably the water-soluble salts of pesticides, and with very particular preference the water-soluble salts of 2,4-D, bentazone, clopyralid, dicamba, fomesafen, glyphosate, MCPA, and paraquat.

The active agrochemical ingredients may also comprise a combination of two or more active agrochemical ingredients, more particularly a combination of two or more pesticides or a combination of one or more pesticides with one or more safeners. Such combinations are especially significant when the intention, for example, is to broaden the activity spectrum of a preparation comprising one or more pesticides, or to prevent more effectively resistances toward certain pesticides.

Combining two or more active agrochemical ingredients in one formulation, especially in an aqueous formulation, is a difficult task, since the active ingredients are usually incompatible with one another and the mixtures are not phase-stable. The alkylglucamides of the formula (I), however, are outstandingly suitable for stabilizing these kinds of fundamentally incompatible compositions.

In another preferred embodiment of the invention, therefore, the compositions comprise as component a) the active agrochemical ingredient glufosinate and at least one further pesticide of component b), preferably at least one further water-soluble pesticide, and very preferably at least one further water-soluble herbicide.

Other especially preferred compositions are those wherein the water-soluble pesticides of component a) comprise a water-soluble salt of glufosinate and in the case of component b) comprise at least one water-soluble auxin.

Especially preferred compositions are those in which the water-soluble pesticides of component a) comprise glufosinate-ammonium and in the case of component b) comprise at least one water-soluble salt of dicamba, preferably dicamba-diglycolammonium and/or sodium dicamba.

With the above-described alkylglucamides of the formula (I) it is possible to produce compositions of the invention, more particularly aqueous herbicide formulations, having excellent performance properties.

In the one or more alkylglucamides of the formula (I) b), the radical R1 is preferably a linear or branched alkyl group having 7 to 9 carbon atoms. The radical R2 is preferably a methyl group.

With particular preference the compositions of the invention comprise a mixture of octanoyl-N-methylglucamide (R1=C₇ alkyl, R2=methyl) and decanoyl-N-methylglucamide (R1=C₉ alkyl, R2=methyl). The proportion of octanoyl-N-methylglucamide in this mixture is 10 to 90 wt %, preferably 20 to 80 wt % and more preferably 30 to 70 wt %, based on the total amount of the alkylglucamides present in this mixture. The proportion of decanoyl-N-methylglucamide in this mixture is 10 to 90 wt %, preferably 20 to 80 wt % and more preferably 30 to 70 wt %, based on the total amount of the alkylglucamides present in this mixture.

The pentahydroxyhexyl radical in the alkylglucamides of the formula (I) possesses various chiral centers, meaning that in each case a number of stereoisomers may exist. The alkylglucamides of the formula (I) are customarily prepared from naturally occurring sugars, such as D-glucose; in principle, however, the use of other natural or synthetic hexoses or other C₆ building blocks is also possible, and so different stereoisomers of the formula (I) may result.

The alkylglucamides of the formula (I) are based preferably on renewable raw materials and are distinguished by an advantageous toxicological and environmental profile. They possess high solubility in water.

The preparation of the alkylglucamides of the formula (I) is subject matter of adequate prior description in EP-A-550,637, for example, and is known to the skilled person. It is accomplished, for example, by condensing carboxylic esters with a secondary N-alkylglucamine, which in turn may be prepared by reductive amination from a sugar such as D-glucose.

The alkylglucamides of the formula (I) are customarily used in the form of solutions. For clarification it should be noted here that the quantity figures stated above relate to the active content of the alkylglucamides of the formula (I) in the solution.

For greater ease of handling, the alkylglucamides of the formula (I) are customarily used in the form of aqueous solutions containing 10 to 90 wt %, more preferably 20 to 80 wt % and especially preferably 30 to 70 wt % of the one or more alkylglucamides of component c). Because of the preparation process, these adjuvant compositions may further comprise, as a secondary component, one or more of the cosolvents d) (see example 1). For clarification it should be noted here that the quantity figures stated above relate to the active content of the alkylglucamides of the formula (I) in the solution.

The compositions of the invention in the form of concentrates preferably comprise 0.1 to 97 wt %, more preferably 1 to 80 wt %, especially preferably 3 to 25 wt % of the one or more alkylglucamides of the formula (I) of component c). The quantity figures here are based on the total weight of the composition. The amounts of the component c) may of course be lowered correspondingly by dilution prior to application.

The one or more cosolvents d) present may either be present as a secondary component from the alkylglucamide preparation process, and/or may have been added to the composition subsequently. The one or more cosolvents may comprise a single di-or trihydric alcohol or a mixture of two or more such alcohols.

In the case of single-phase, aqueous-organic solutions, the entirely or largely water-miscible di-or trihydric alcohols or alcohol mixtures are suitable.

Suitable cosolvents are di-or trihydric alcohols, such as ethylene glycol, diethylene glycol, propylene glycol, glycerol or polyglycols, such as polyethylene glycols, polypropylene glycols and/or mixed polyalkylene glycols (PAGs) and very preferably glycerol, propylene glycol and dipropylene glycol.

The presence of the cosolvent is mandatory for stabilizing the composition of the invention. The cosolvent increases, for example, the low-temperature stability or heat stability and/or influences further performance properties such as the viscosity in a positive way. Moreover, glycerol and ethylene glycols in particular act as evaporation inhibitors (humectants), this being beneficial to the properties of the spray coating.

The proportion of the cosolvent or cosolvents in the composition of the invention in the form of concentrates is customarily up to 30 wt %, preferably 1 to 25 wt % and more preferably 2 to 20 wt %. The quantity figures here are based on the total weight of the composition. The amounts of component d) may of course be lowered correspondingly by dilution prior to application.

As a result of the high salt stability of the alkylglucamides of the formula (I) used in the composition of the invention, in the aqueous medium, even at high active ingredient concentration and salt concentration, it is possible to produce agrochemical preparations, more particularly pesticide preparations, of high salt stability, this representing a great performance advantage. This also makes it possible for nitrogen-containing fertilizers such as ammonium salts, for example, to be included in the compositions.

The one or more nitrogen-containing salts of component e) may be fertilizers or else salts which are used for conditioning the formulation. Component e) preferably comprises ammonium salts and/or urea. With particular preference it comprises one or two ammonium salts, and very preferably a water-soluble ammonium salt.

Preferred water-soluble ammonium salts are ammonium sulfate, ammonium nitrate, ammonium nitrate urea, ammonium phosphate, ammonium citrate, ammonium thiocyanate, ammonium thiosulfate and/or ammonium chloride, more preferably ammonium sulfate, ammonium nitrate and/or ammonium nitrate urea, ammonium citrate and very preferably ammonium sulfate.

The proportion of component e) in the compositions of the invention in the form of concentrates is typically 0.01 to 25 wt %, preferably 0.1 to 20 wt %, more preferably 1 to 20 wt %, and very preferably 3 to 15 wt %. The quantity figures here are based on the total weight of the composition. The amounts of component e) may of course be lowered correspondingly by dilution prior to application.

Suitable surfactants for component f) include anionic, nonionic, cationic and/or zwitterionic surfactants. Examples of such surfactants are listed below (where in each case EO=ethylene oxide units, PO=propylene oxide units, and BO=butylene oxide units from the standpoint of preparation, and corresponding alkyleneoxy units in the surfactant molecules):

Anionic surfactants such as, for example:
1 anionic derivatives of fatty alcohols having 10-24 carbon atoms with 0-60 EO and/or 0-20 PO and/or 0-15 BO in any order, in the form of ether carboxylates, sulfonates, sulfates and phosphates and their inorganic (e.g. alkali metal and alkaline earth metal) and organic (e.g., amine-based or alkanolamine-based) salts, such as Genapol® LRO, Sandopan® products, Hostaphat/Hordaphos® products from Clariant;
2. anionic derivatives of copolymers consisting of EO, PO and/or BO units with a molecular weight of 400 to 10⁸, in the form of ether carboxylates, sulfonates, sulfates and phosphates and their inorganic (e.g., alkali metal and alkaline earth metal) and organic (e.g., amine-based or alkanolamine-based) salts;
3. anionic derivatives of alkylene oxide adducts of C₁-C₉ alcohols in the form of ether carboxylates, sulfonates, sulfates and phosphates and their inorganic (e.g., alkali metal and alkaline earth metal) and organic (e.g., amine-based or alkanolamine-based) salts, provided their structures do not fall within the definition of the alkyl ether sulfates of component (c); d1-4) anionic derivatives of fatty acid alkoxylates in the form of ether carboxylates, sulfonates, sulfates and phosphates and their inorganic (e.g., alkali metal and alkaline earth metal) and organic (e.g., amine-based or alkanolamine-based) salts;

Cationic or zwitterionic surfactants such as, for example:
1. alkylene oxide adducts of fatty amines, quaternary ammonium compounds having 8 to 22 carbon atoms (C₈-C₂₂) such as, for example, the Genamin® C, L, O, T products from Clariant;
2. surface-active zwitterionic compounds such as taurides, betaines and sulfobetaines in the form of Tegotain® products from Goldschmidt, Hostapon® T and Arkopon® T products from Clariant.

Nonionic surfactants such as, for example:
1. fatty alcohols having 8-24 carbon atoms with 0-60 EO and/or 0-20 PO and/or 0-15 BO in any order. Examples of such compounds are Genapol® C., L, O, T, UD, UDD and X products from Clariant, Plurafac® and Lutensol® A, AT, ON and TO products from BASF, Marlipal® 24 and 013 products from Condea, Dehypon® products from Henkel, Ethylan products from Akzo-Nobel such as Ethylan CD 120;
2. fatty acid alkoxylates and triglyceride alkoxylates such as the Serdox® NOG products from Condea or the Emulsogen® products from Clariant;
3. fatty acid amide alkoxylates such as the Comperlan products from Henkel or the Amam® products from Rhodia;
4. alkylene oxide adducts of alkynediols such as the Surfynol® products from Air Products; sugar derivatives such as amino and amido sugars from Clariant;
5. glucitols from Clariant;
6. silicone-based and/or silane-based surface-active compounds such as the Tegopren® products from Goldschmidt and the SE® products from Wacker, and also the Bevaloid®, Rhodorsil® and Silcolapse® products from Rhodia (Dow Corning, Reliance, GE, Bayer),
7.surface-active sulfonamides e.g. from Bayer;
8. surface-active polyacrylic and polymethacrylic derivatives such as the Sokalan® products from BASF;
9. surface-active polyamides such as modified gelatins or derivatized polyaspartic acid from Bayer and derivatives thereof,
10. surfactant polyvinyl compounds such as modified PVP such as the Luviskol® products from BASF and the Agrimer® products from ISP or the derivatized polyvinyl acetates such as the Mowilith® products from Clariant or the polyvinyl butyrates such as the Lutonal® products from BASF, the Vinnapas® and the Pioloform® products from Wacker or modified polyvinyl alcohols such as the Mowiol® products from Clariant,
11. surface-active polymers based on maleic anhydride and/or reaction products of maleic anhydride and also copolymers containing maleic anhydride and/or reaction products of maleic anhydride, such as the Agrimer® VEMA products from ISP,
12. surface-active derivatives of montan waxes, polyethylene waxes and polypropylene waxes, such as Hoechst® waxes or the Licowet® products from Clariant,
13. polyol-based alkylene oxide adducts such as Polyglykol® products from Clariant,
14. surface-active polyglycerides and derivatives thereof from Clariant
15. alkylpolysaccharides and mixtures thereof such as, for example, from the Atplus® range from Uniqema, preferably Atplus 435,
16. alkylpolyglycosides in the form of APG® products from Henkel, as for example Plantaren® APG 225 (fatty alcohol C₈-C₁₀ glucoside),
17. sorbitan esters in the form of the Span® or Tween® products from Uniqema,
18. cyclodextrin esters or cyclodextrin ethers from Wacker,
19. surface-active cellulose derivatives and algin derivatives, pectin derivatives and guar derivatives such as the Tylose® products from Clariant, the Manutex® products from Kelco and guar derivatives from Cesalpina,
20. alkylpolyglycoside/alkylpolysaccharide mixtures based on C₈-C₁₀ fatty alcohol, such as Glucopon® 225 DK and Glucopon® 215 CSUP (BASF).

Preferred surfactants of component f) are anionic surfactants, particular preference being given to alkyl polyglycol ether sulfates, especial preference being given to fatty alcohol diethylene glycol ether sulfate (e.g., Genapol LRO®, Clariant), or alkyl polyglycol ether carboxylates (e.g., 2-(isotridecyloxy-polyethyleneoxy)ethyl carboxymethyl ether, Marlowet 4538®, Hüls), the amount and the nature of the additional anionic surfactants being usefully selected so as not to result in any unacceptable foaming behavior on the part of the formulation.

The compositions of the invention in the form of concentrates preferably comprise up to 25 wt %, more preferably up to 20 wt %, especially preferably 1 to 20 wt %, and very preferably 3 to 15 wt % of the one or more surfactants of component f). The quantity figures here are based on the total weight of the composition. The amounts of components f) may of course be lowered correspondingly by dilution prior to application.

The compositions of the invention may optionally comprise further customary formulating assistants as component g). Examples of such assistants are solvents, inert materials, such as stickers, wetters, dispersants, emulsifiers, penetrants, preservatives, fillers, carriers and colorants, and pH modifiers (buffers, acids and bases) or viscosity modifiers (e.g., thickeners), and optionally also defoamers, the latter being sensible at most in reduced quantity. Customary formulating assistants g) are, for example, the stated inert materials, evaporation inhibitors, preservatives and/or colorants.

The compositions of the invention preferably comprise defoamers, colorants, and pH modifiers as formulating assistants g).

Possible as component g), for example, are polar or nonpolar organic solvents or polar or nonpolar inorganic solvents or mixtures thereof. They additionally contain water as component h).

Examples of nonpolar solvents in the sense of the invention are
aliphatic or aromatic hydrocarbons, such as mineral oils or toluene, xylenes, and naphthalene derivatives,
halogenated aliphatic or aromatic hydrocarbons such as methylene chloride or chlorobenzene,
oils, plant-based oils such as corn germ oil and rapeseed oil, for example, or oil derivatives such as rapeseed oil methyl ester.

Examples of polar solvents in the sense of the invention are
polar ethers such as tetrahydrofuran (THF), dioxane, alkylene glycol monoalkyl and dialkyl ethers such as, for example, propylene glycol monomethyl ether, propylene glycol monoethyl ether, ethylene glycol monomethyl ether or monoethyl ether, diglyme and tetraglyme;
amides such as dimethylformamide (DMF), dimethylacetamide, dimethylcaprylamide, dimethylcapramide (®Hallcomide) and N-alkylpyrrolidones;
ketones such as acetone;
esters based on glycerol and carboxylic acids, such as glycerol mono-, di-and triacetate,
lactams,
lactate esters having chain lengths of 1 to 10 C atoms in the ester moiety,
carbonic diesters;
nitriles such as acetonitrile, propionitrile, butyronitrile, and benzonitrile;
sulfoxides and sulfones such as dimethyl sulfoxide (DMSO) and sulfolane.

Also frequently suitable are combinations of different solvents, additionally comprising alcohols such as methanol, ethanol, n- and isopropanol, n-, iso-, tert-and 2-butanol.

The compositions of the invention may optionally comprise defoamers as component g). The defoamers may comprise a single defoamer or a mixture of two or more defoamers. Suitable defoamers are fatty acid alkyl ester alkoxylates, organopolysiloxanes such as polydimethylsiloxanes and mixtures thereof with microfine, optionally silanized silica, perfluoroalkylphosphonates, perfluoroalkylphosphinates, paraffins, waxes and microcrystalline waxes and mixtures thereof with silanized silica. Also advantageous are mixtures of different foam inhibitors, examples being those of silicone oil, liquid paraffin and/or waxes.

The compositions of the invention may optionally comprise preservatives as component g). The preservatives may be a single preservative or a mixture of two or more preservatives. Preservatives which can be used are organic acids and their esters, examples being ascorbic acid, ascorbyl palmitate, sorbate, benzoic acid, methyl 4-hydroxybenzoate, propyl 4-hydroxybenzoate, propionates, phenol, 2-phenyl phenate, 1,2-benzisothiazolin-3-one, formaldehyde, sulfurous acid, and salts thereof. Examples include Mergal K9N® (Riedel) or Cobate C®.

The compositions of the invention may optionally comprise drift retardants as component g). The drift retardants may comprise a single drift retardant or a mixture of two or more drift retardants. Drift retardants used may be water-soluble polymers, as for example polyacrylamides, acrylamide/acrylic acid polymers, sodium polyacrylate, carboxymethylcellulose, hydroxyethylcellulose, methylcellulose, polysaccharides, and natural and synthetic guar gum. It is also possible, furthermore, for certain emulsions or self-emulsifying systems to be used as drift retardants. An example that may be given here is InterLock® (Winfield).

The compositions of the invention in the form of concentrates may comprise up to 50 wt % of one or more formulating assistants of component g), preferably up to 20 wt %, and more preferably up to 15 wt %. The quantity figures here are based on the total weight of the composition. The amounts of component g) may of course be lowered correspondingly by dilution prior to application.

The compositions of the invention in the form of concentrates may comprise 0.01 up to 95 wt % of water of component h), preferably 0.1 to 90 wt %, more preferably 5 to 85 wt % and very preferably 10 to 60 wt %. The quantity figures here are based on the total weight of the composition. The amount of component h) may of course be raised correspondingly by dilution with water prior to application.

In one preferred embodiment of the invention the compositions of the invention take the form of concentrate formulations containing
a) 1 to 40 wt %, preferably 10 to 35 wt %, more particularly 15 to 30 wt %, of the active agrochemical ingredient glufosinate,
b) 0 to 40 wt %, preferably 1 to 40 wt %, more preferably 2 to 30 wt %, more particularly 5 to 20 wt %, of one or more further active agrochemical ingredients,
c) 0.1 to 97 wt %, preferably 1 to 80 wt %, more particularly 2 to 70 wt %, especially 5 to 60 wt % of one or more of the alkylglucamides of the formula (I),

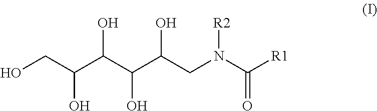

where
R1 is a linear or branched alkyl group having 5 to 9 carbon atoms, and
R2 is an alkyl group having 1 to 3 carbon atoms,
d) 1 to 30 wt %, preferably 1 to 25 wt %, more particularly 2 to 20 wt %, and especially preferably 5 to 15 wt % of one or more di-or trihydric alcohol cosolvents,
e) 0 to 25 wt %, preferably 0.1 to 20 wt %, more particularly 1 to 20 wt %, especially 3-15 wt % of nitrogen-containing salts and/or urea,
f) 0 to 25 wt %, preferably 0 to 20 wt %, more particularly 1 to 20 wt %, especially 3-15 wt % of surfactants,
g) 0 to 50 wt %, preferably 0 to 20 wt %, preferably 0 to 15 wt %, of further customary formulating assistants, and
h) 0.01 to 95 wt %, preferably 0.1 to 90 wt %, more preferably 5 to 85 wt % of water, more particularly 10 to 60 wt % of water.

“wt %” here means in each case “weight percent”, i.e., the ratio of weight of the constituent to weight of the preparation, in percent. Also preferred are compositions in which the amount of the components consists of a combination of two or more of the proportions of the components that are stated as being preferred.

In the formulation of active agrochemical ingredient preparations, efforts are made to load the composition with a maximum concentration of active agrochemical ingredient. This reduces costs of packaging, transport, storage, and disposal. An adjuvant ought therefore to be capable of enabling stable, highly loaded active ingredient compositions, known as “high-load formulations”. This is accomplished with the alkylglucamides of the formula (I) in combination with di- or trihydric alcohol cosolvents.

In one preferred embodiment of the invention, the amount of the one or more active agrochemical ingredients of component a) in the compositions of the invention is more than 10 wt %, preferably more than 20 wt % and more preferably more than 30 wt %. These quantity figures are based on the overall composition of the invention and, in the case of active agrochemical ingredients which are used in the form of their water-soluble salts (such as customarily, for example, glufosinate, dicamba, glyphosate or 2,4-D), on the amount of free acid, the so-called acid equivalent (a.e.).

An important criterion for the storage stability of aqueous formulations of active agrochemical ingredients, such as pesticide preparations-glufosinate, glyphosate, dicamba and 2,4-D formulations, for example-is the phase stability. A preparation is considered sufficiently phase-stable when it remains homogenous over a wide temperature range and there is no development of two or more separate phases and no precipitation (formation of a further, solid phase). Phase stability is the critical requirement for a storage-stable formulation not only at elevated temperature, as may occur, for example, during storage in the sun or in hot countries, but also at low temperature, as in the winter or in cold climatic regions, for example.

A feature of the compositions of the invention is that they are phase-stable both at elevated temperatures, preferably at temperatures greater than 55° C., and at low temperatures, preferably at temperatures of less than 10° C., more preferably of less than 0° C. and especially preferably of less than −10° C.

The pH of the compositions is situated customarily in the range from 3.5 to 8.0, being preferably 4.0 to 7.0 and more preferably 4.5 to 6.5 (measured as a 1 wt % strength aqueous dilution). The pH is determined primarily by the pH values of the solutions of the aqueous pesticides present in the form of salts of weak acids. By adding acids, bases or buffer salts, the pH may be adjusted to a different value in deviation from the original pH of the mixture.

Production of the compositions of the invention is well known to the skilled person, and the auxiliaries needed for producing the compositions of the invention, such as surfactants in particular, are known in principle and are described for example in: McCutcheon's “Detergents and Emulsifiers Annual”, MC Publ. Corp., Ridgewood N.J.; Sisley and Wood, “Encyclopedia of Surface active Agents”, Chem. Publ. Co. Inc., N.Y. 1964; Schönfeldt, “Grenzflächenaktive Äthylenoxidaddukte”, Wiss. Verlagsgesellschaft, Stuttgart 1976; Winnacker-Küchler, “Chemische Technologie”, Volume 7, C. Hanser-Verlag, Munich, 4th edition 1986, and references cited in each of these publications.

The liquid formulations of the invention can be produced by methods that are customary in principle, i.e., by mixing the components with stirring, shaking or by means of static mixing techniques. The resulting liquid formulations are stable and highly storable.

A further subject of the invention is a method for producing the compositions of the invention, characterized in that components a) to h) and optionally further components present in the composition are mixed.

The compositions of the invention are used preferably in spray mixtures or in preparations intended for production of spray mixtures; in the spray mixtures, the active agrochemical ingredients, more particularly the pesticides, are preferably wholly or partly water-soluble; that is, they are in solution generally at 1 to 100 weight percent, preferably 5 to 100 weight percent, more preferably at 10 to 100 weight percent, more particularly at 20 to 100 weight percent, very particularly at 30 to 100 weight percent, based on the weight of the active agrochemical ingredient, in the spray mixture, and preferably at the active ingredient concentrations that are customary in practice.

These active ingredients may be used both in individual formulations or in coformulation of active agrochemical ingredients or as additions to tank mixes. On account of their surface-active properties, the alkylglucamides of the formula (I) accelerate the uptake of the one or more active agrochemical ingredients into the plant, more particularly their uptake via the leaf of the plant, and so contribute to improved activity of the active ingredients.

Another subject of the invention is the use of the one or more alkylglucamides of the formula (I), optionally in combination with further surfactants, for accelerating the uptake of glufosinate into a plant, more particularly for accelerating the uptake of glufosinate via the leaf of a plant.

Surprisingly, the surface-active properties of the alkylglucamides of the formula (I) that are used in accordance with the invention produce favorable improvements in activity in combination with substantially reduced foaming tendency on the part of the preparations or spray mixtures.

Another subject of the invention is the use of the one or more alkylglucamides of the formula (I), optionally in combination with further surfactants, for reducing the foaming tendency of compositions which comprise glufosinate as active agrochemical ingredient.

The amount of alkylglucamides of the formula (I) in the compositions is usefully selected such that when the spray mixtures are prepared, the result is a nonfoaming or comparatively low-foaming spray mixture. The weight ratio of the one or more active agrochemical ingredients of component a) and optionally b) (based on 100% active agrochemical ingredient) to alkylglucamides of the formula (I) may vary within wide ranges and is preferably in the range from 1:0.1 to 1:10, more particularly 1:0.5 to 1:5.

The liquid preparations comprising one or more active agrochemical ingredients are low in foam and storable. On application, they generally have favorable, in many cases very favorable, technical properties. For example, the formulations are distinguished by low foaming tendency on dilution with water, as when producing tank mixes and when applying the formulations in a spraying process, for example. On application, moreover, the pesticide preparations of the invention exhibit a comparatively very good biological effect when the effect is compared with the effect of the known formulations with long-chain alkyl ether sulfates (e.g., with the commercial formulation Ignite SL 280 from Bayer).

The compositions of the invention are delivered preferably in the form of spray mixtures onto the fields. The spray mixtures in this case are produced by diluting concentrate formulations with a defined amount of water.

In a further preferred embodiment of the invention, the compositions of the invention take the form of spray mixtures and contain
0.001 to 10 wt %, preferably 0.02 to 3 wt % and more preferably 0.025 to 2 wt % of glufosinate,
0.001 to 10 wt %, preferably 0.02 to 3 wt % and more preferably 0.025 to 2 wt % of the one or more further water-soluble pesticides of component b).

The stated quantity figures are based on the entire spray mixture and, in the case of active agrochemical ingredients which are used in the form of their water-soluble salts, on the amount of free acid, the so-called acid equivalent (a.e.).

The invention further relates to the use of the compositions of the invention for checking and/or controlling weeds, fungal diseases or insect infestation in plants. A preferred use of the compositions of the invention is for checking and/or controlling weeds.

The compositions of the invention are very highly suited to the control of unwanted plant growth both on noncrop land and in tolerant crops.

Where selective herbicides are employed as pesticides of component b), or where insecticides, fungicides or fertilizers are used, the compositions of the invention, as low-foam, high-activity formulations, can be used alone or in combination in the monocotyledonous and dicotyledonous crops customary for the active ingredients, as for example in economically significant crops such as cereals (wheat, barley, triticale, rye, rice, corn, millet), sugar beet, sugar cane, oilseed rape, cotton, sunflower, peas, beans, and soybeans. Of particular interest in this context is their use in monocotyledonous crops such as cereals (wheat, barley, rye, triticale, sorghum), including corn and rice, and in monocotyledonous vegetable crops, but also in dicotyledonous crops such as, for example, soybeans, oilseed rape, cotton, grapevines, vegetable plants, fruit plants, and ornamental plants.

The compositions of the invention, comprising one or more active agrochemical ingredients of component a), may be used alone or in combination with other active agrochemical ingredients of component b), and/or nitrogen-containing fertilizers of component e) on noncrop land, in patches of useful plants and ornamental plants, or in suitable tolerant crops, and/or, at suitable times, in nontolerant crops. Of interest in this context, as well as the aforementioned tolerant crops of useful plants, such as the (LibertyLink or Roundup-Ready® crops), for the production of field crops, are also crops for ornamental and utility areas, such as turf. For example, the compositions of the invention with glufosinate(-ammonium) are suitable, with or without fertilizer, for application in the control of harmful plants on ornamental or utility turf areas, especially lolium, meadow-grass or Bermuda grass, preferably specifically in glufosinate-tolerant turf cultures.

### EXAMPLES

The invention is illustrated below by examples which, however, should in no way be seen as imposing any restriction.

The percentage figures stated below are weight percent (wt %), unless explicitly stated otherwise.

| | |
|---|---|
| Pesticide A | glufosinate ammonium salt (98 wt % active), |
| | from Schirm |
| Pesticide B | dicamba acid (98 wt % active), from Schirm |
| Counterion B | diglycolamine, from Huntsman |
| Adjuvant A | lauryl ether sulfate (68 wt % active), from Clariant |
| Adjuvant B | C8/10 glucamide (see example 1), from Clariant |
| AMS | ammonium sulfate, from Redox |
| Cosolvent A | 1,2-propylene glycol, from Clariant |
| Cosolvent B | dipropylene glycol, from Merck |
| Cosolvent C | glycerol, from Merck |
| Solvent | 1-methoxy-2-propanol, from Alfa Aesar |
| Buffer salt | diammonium hydrogen citrate, from Merck |
| Defoamer | silicone-based defoamer from Momentive |
| Water | deionized water or mains water |

The raw materials used are as follows:

### Example 1

### Preparation of the C₈/C₁₀Glucamide (Adjuvant B)

The solution with 50 wt % C₈/C₁₀ glucamide active substance was prepared as follows: first of all, according to EP-A-550,637 C₈/C₁₀ fatty acid methyl ester (methyl octanoate:methyl decanoate =55:45) is reacted with N-methylglucamine in the presence of 1,2-propylene glycol as solvent to give a solid consisting of 90 wt % active substance and 10 wt % 1,2-propylene glycol. This solid was dissolved in water at 40 to 50° C. to give a solution with a linear C₈/C₁₀ glucamide content of 50 wt %. This is a clear, colorless solution.

The use concentrations in the following examples are always based on the product tested, and for the linear C₈/C₁₀ glucamide itself the composition in question is always the stable solution with 50 wt % active substance content in water/propylene glycol.

### Example 2

### Aqueous Glufosinate Formulations (Glufosinate-Ammonium 280 g/l a.e.)

The glufosinate-ammonium preparations A1-A14 identified in table 1 were produced by mixing the various components with water. The preparations are then stored for two weeks at −10° C., 0° C., 25° C. (room temperature) and 54° C. in order to determine the storage stability and the phase behavior.

TABLE 1
Composition of aqueous glufosinate formulations (glufosinate-ammonium 280 g/l a.e.)

| | | Example | | | | | | | | |
|---|---|---|---|---|---|---|---|---|---|---|
| | | A1 | A2 | A3 | A4 | A5 | A6 | A7 | A8 | A9 |
| | | (Reference*) | noninventive | noninventive | noninventive | Invention | Invention | Invention | Invention | Invention |
| Pesticide A | [wt %] | 24.84 | 24.84 | 24.84 | 25.09 | 25.09 | 25.09 | 25.09 | 25.09 | 18.02 |
| Adjuvant A | [wt %] | 25.0 | 25.0 | 25.0 | 0 | 0 | 0 | 0 | 0 | 0 |
| Adjuvant B | [wt %] | 0 | 0 | 0 | 20 | 50.0 | 20.0 | 20.0 | 20.0 | 50 |
| AMS | [wt %] | 0 | 0 | 2.5 | 5.0 | 0 | 5.0 | 5.0 | 5.0 | 0 |
| Cosolvent A | [wt %] | 0 | 0 | 0 | 0 | 10 | 0 | 0 | 0 | 10 |
| Cosolvent B | [wt %] | 10.0 | 0 | 10.0 | 0 | 0 | 0 | 0 | 10.0 | 0 |
| Cosolvent C | [wt %] | 0 | 10.0 | 0 | 0 | 0 | 10 | 10 | 0 | 0 |
| Solvent | [wt %] | 5.0 | 5.0 | 5.0 | 2.0 | 1.0 | 2.0 | 2.0 | 2.0 | 0 |
| Buffer salt | [wt %] | 0 | 0 | 0 | 1.0 | 1.0 | 1.0 | 1.0 | 1.0 | 1.0 |
| Water | [wt %] | 35.06 | 35.06 | 32.56 | 46.89 | 12.81 | 36.81 | 36.89 | 36.89 | 20.96 |
| Defoamer A | [wt %] | 0.1 | 0.1 | 0.1 | 0.02 | 0.1 | 0.1 | 0.02 | 0.02 | 0.02 |

| | | | | | | | | | |
|---|---|---|---|---|---|---|---|---|---|
| Appearance 54° C. | homogeneous | separates | separates | separates | homogeneous | homo- | homo- | homo- | homo- |
| | | | | | | geneous | geneous | geneous | geneous |
| Appearance 25° C. | homogeneous | separates | separates | separates | homogeneous | homo- | homo- | homo- | homo- |
| | | | | | | geneous | geneous | geneous | geneous |
| Appearance 0° C. | homogeneous | separates | separates | separates | homogeneous | homo- | homo- | homo- | homo- |
| | | | | | | geneous | geneous | geneous | geneous |
| Appearance −10° C. | homogeneous | separates | separates | separates | frozen | frozen | frozen | homo- | homo- |
| | | | | | | | | geneous | geneous |

| | | Example | | | | |
|---|---|---|---|---|---|---|
| | | A10 | A11 | A12 | A13 | A14 |
| | | Invention | Invention | Invention | Invention | Invention |
| Pesticide A | [wt %] | 25.09 | 25.09 | 25.09 | 25.09 | 25.09 |
| Adjuvant A | [wt %] | 0 | 0 | 0 | 0 | 0 |
| Adjuvant B | [wt %] | 20.0 | 20.0 | 20.0 | 36.81 | 30.0 |
| AMS | [wt %] | 5.0 | 5.0 | 10.0 | 5.0 | 10.0 |
| Cosolvent A | [wt %] | 0 | 20.0 | 10.0 | 0 | 0 |
| Cosolvent B | [wt %] | 0 | 0 | 0 | 10.0 | 0 |
| Cosolvent C | [wt %] | 20.0 | 0 | 0 | 0 | 10.0 |
| Solvent | [wt %] | 2.0 | 2.0 | 2.0 | 2.0 | 2.0 |
| Buffer salt | [wt %] | 1.0 | 1.0 | 1.0 | 1.0 | 1.0 |
| Water | [wt %] | 26.89 | 26.89 | 31.89 | 20.08 | 26.89 |
| Defoamer A | [wt %] | 0.02 | 0.02 | 0.02 | 0.02 | 0.02 |

| | | | | | |
|---|---|---|---|---|---|
| Appearance 54° C. | homogeneous | homogeneous | homogeneous | homogeneous | homogeneous |
| Appearance 25° C. | homogeneous | homogeneous | homogeneous | homogeneous | homogeneous |
| Appearance 0° C. | homogeneous | homogeneous | homogeneous | homogeneous | homogeneous |
| Appearance −10° C. | homogeneous | frozen | homogeneous | homogeneous | frozen |

*analogous to glufosinate-ammonium formulation Ignite ® SL 280 from Bayer

The inventive compositions are homogeneous and phase-stable at 0° C., room temperature (approximately 25° C.) and 54° C. At −10° C. some of the inventive compositions become solid, but revert to a homogeneous and phase-stable state at 0° C. Comparative example A4 and examples A8 show that the presence of a selected cosolvent is needed in order to ensure the phase stability of the formulation.

### Example 3

### Aqueous Glufosinate—DIcamba-Combi Formulations (200 g/l a.e. Glufosinate-Ammonium and 200 g/l a.e. Dicamba DGA)

The glufosinate-ammonium preparations B1-B8 identified in table 2 were produced by mixing the various components with water. The preparations are then stored for two weeks at −10° C., 0° C., 25° C. (room temperature) and 54° C. to determine the storage stability and the phase behavior.

TABLE 2
Composition of glufosinate - dicamba combi formulations (200 g/l a.e. glufosinate-ammonium and 200 g/l a.e.
dicamba DGA)

| | | Example | | | | | | | |
|---|---|---|---|---|---|---|---|---|---|
| | | B1 | B2 | B3 | B4 | B5 | B6 | B7 | B8 |
| | | noninventive | noninventive | Invention | Invention | Invention | Invention | Invention | Invention |
| Pesticide A | [wt %] | 18.87 | 18.87 | 18.87 | 18.87 | 18.87 | 18.87 | 18.87 | 18.87 |
| Pesticide B | [wt %] | 17.24 | 17.24 | 17.24 | 17.24 | 17.24 | 17.24 | 17.24 | 17.24 |
| Counterion B | [wt %] | 8.11 | 8.11 | 8.11 | 8.11 | 8.11 | 8.11 | 8.11 | 8.11 |
| Adjuvant A | [wt %] | 25.0 | 0 | 0 | 0 | 0 | 0 | 0 | 0 |
| Adjuvant B | [wt %] | 0 | 25.0 | 25.0 | 25.0 | 25.0 | 25.0 | 25.0 | 25.0 |
| AMS | [wt %] | 0 | 0 | 0 | 0 | 0 | 0 | 0 | 5 |
| Cosolvent A | [wt %] | 9.5 | 0 | 9.5 | 15.0 | 0 | 0 | 0 | 9.50 |
| Cosolvent B | [wt %] | 0 | 0 | 0 | 0 | 0 | 0 | 9.50 | 0 |
| Cosolvent C | [wt %] | 0 | 0 | 0 | 0 | 9.50 | 15.0 | 0 | 0 |
| Solvent | [wt %] | 2.0 | 2.0 | 2.0 | 2.0 | 2.0 | 2.0 | 2.0 | 2.0 |
| Buffer salt | [wt %] | 1.0 | 1.0 | 1.0 | 1.0 | 1.0 | 1.0 | 1.0 | 1.0 |
| Water | [wt %] | 18.26 | 27.76 | 18.26 | 12.76 | 18.26 | 12.76 | 12.76 | 13.26 |
| Defoamer A | [wt %] | 0.02 | 0.02 | 0.02 | 0.02 | 0.02 | 0.02 | 0.02 | 0.1 |

| | | | | | | | | |
|---|---|---|---|---|---|---|---|---|
| Appearance 54° C. | homo- | separates | homo- | homogeneous | homogeneous | homogeneous | homogeneous | homogeneous |
| | geneous | | geneous | | | | | |
| Appearance 25° C. | homo- | separates | homo- | homogeneous | homogeneous | homogeneous | homogeneous | homogeneous |
| | geneous | | geneous | | | | | |
| Appearance 0° C. | separates | separates | homo- | homogeneous | homogeneous | homogeneous | homogeneous | homogeneous |
| | | | geneous | | | | | |
| Appearance −10° C. | separates | separates | homo- | homogeneous | homogeneous | homogeneous | homogeneous | homogeneous |
| | | | geneous | | | | | |

The inventive compositions are homogeneous and phase-stable at −10° C., 0° C., room temperature (approximately 25° C.) and 54° C.

Comparative example B2 and examples B3 to B7 show that the presence of a selected cosolvent is necessary in order to ensure the phase stability of the formulation.

### Example 4

### Aqueous High-Load Glufosinate Formulations (350 g/l a.e. Glufosinate-Aammonium)

The glufosinate-ammonium preparations C1-C7 identified in table 3 are produced by mixing the various components with water. The preparations are then stored for two weeks at −10° C., 0° C., 25° C. (room temperature) and 54° C. in order to determine the storage stability and the phase behavior.

TABLE 3
Composition of high-load glufosinate formulations (350 g/l a.e. glufosinate-ammonium)

| | | Example | | | | | | | |
|---|---|---|---|---|---|---|---|---|---|
| | | C1 | C2 | C3 | C4 | C5 | C6 | C7 | C8 |
| | | noninventive | noninventive | Invention | Invention | Invention | Invention | Invention | Invention |
| Pesticide A | [wt %] | 30.84 | 30.84 | 30.84 | 30.84 | 30.84 | 30.84 | 30.84 | 30.84 |
| Adjuvant A | [wt %] | 25.0 | 0 | 0 | 0 | 0 | 0 | 0 | 0 |
| Adjuvant B | [wt %] | 0 | 50.0 | 50.0 | 50.0 | 30.0 | 30.0 | 30.0 | 30.0 |
| AMS | [wt %] | 0 | 0 | 0 | 0 | 0 | 0 | 5.0 | 5.0 |
| Cosolvent A | [wt %] | 0 | 0 | 10.0 | 15.0 | 10.0 | 15.0 | 10.0 | 15.0 |
| Cosolvent B | [wt %] | 10.0 | 0 | 0 | 0 | 0 | 0 | 0 | 0 |
| Cosolvent C | [wt %] | 0 | 0 | 0 | 0 | 0 | 0 | 0 | 0 |
| Solvent | [wt %] | 1.0 | 1.0 | 1.0 | 1.0 | 1.0 | 1.0 | 1.0 | 1.0 |
| Buffer salt | [wt %] | 0 | 1.0 | 1.0 | 1.0 | 1.0 | 1.0 | 1.0 | 1.0 |
| Water | [wt %] | 32.14 | 17.14 | 7.14 | 2.14 | 27.14 | 22.14 | 22.14 | 17.14 |
| Defoamer A | [wt %] | 0.02 | 0.02 | 0.02 | 0.02 | 0.02 | 0.02 | 0.02 | 0.02 |

| | | | | | | | | |
|---|---|---|---|---|---|---|---|---|
| Appearance 54° C. | separates | separates | homo- | homogeneous | homogeneous | homogeneous | homogeneous | homogeneous |
| | | | geneous | | | | | |
| Appearance 25° C. | separates | separates | homo- | homogeneous | homogeneous | homogeneous | homogeneous | homogeneous |
| | | | geneous | | | | | |
| Appearance 0° C. | separates | separates | homo- | homogeneous | homogeneous | homogeneous | homogeneous | homogeneous |
| | | | geneous | | | | | |
| Appearance −10° C. | separates | separates | frozen | homogeneous | frozen | homogeneous | frozen | homogeneous |

The inventive compositions are homogeneous and phase-stable at 0° C., room temperature (approximately 25° C.) and 54° C. At −10° C. some of the inventive compositions become solid, but revert to the homogeneous and phase-stable state at 0° C.

### Example 5

### Foam Test

Selected formulations from tables 1, 2 and 3 were each diluted in 100 ml of CIPAC D (342 ppm) water with stirring to give a 1.2% strength solution, and were inverted 30 times. The volume of foam formed and the remaining volume of foam were determined after 10 seconds, 1 minute, 3 minutes, and 12 minutes (see foam assessment according to CIPAC MT 47.2).

TABLE 4
Remaining foam volume after 10 seconds, 1 minute,
3 minutes, and 12 minutes

| | Concen- | Remaining foam volume in % | | | |
|---|---|---|---|---|---|
| | tration- | After | After | After | After |
| Formulation | [wt %] | 10 s | 1 min | 3 min | 12 min |
| A1 (Reference) | 1.2 | 95 | 88 | 81 | 64 |
| A5 (Invention) | 1.2 | 42 | 5 | 1 | 0 |
| A6 (Invention) | 1.2 | 6 | 1 | 0 | 0 |
| A8 (Invention) | 1.2 | 12 | 0 | 0 | 0 |
| A12 (Invention) | 1.2 | 10 | 0 | 0 | 0 |
| A13 (Invention) | 1.2 | 62 | 55 | 39 | 4 |
| A14 (Invention) | 1.2 | 24 | 0 | 0 | 0 |
| B1 (noninventive) | 1.2 | 99 | 96 | 93 | 80 |
| B6 (Invention) | 1.2 | 18 | 0 | 0 | 0 |
| C5 (Invention) | 1.0 | 21 | 7 | 5 | 2 |
| C7 (Invention) | 1.0 | 26 | 11 | 6 | 4 |

The inventive compositions, in comparison to the reference and to noninventive compositions, exhibit significantly reduced foaming.

### Example 6

### Dynamic Surface Tension

The dynamic surface tension was determined via the bubble pressure method (BP2100 tensiometer, Krüss). In a timespan relevant for the spray application of agrochemicals in aqueous dilution (and referred to as the surface age in the bubble pressure method) of 200 milliseconds (ms), the value of the dynamic surface tension in [mN/m] correlates with the sticking to poorly wettable plants such as barley (cereal). A figure of 50 mN/m (at 20-21° C.) relative to water (72.8 mN/m) produces an improvement in sticking from “zero sticking” (0%) to about 50% (Baur P., Pontzen R.; 2007; Basic features of plant surface wettability and deposit formation and the impact of adjuvant; in R. E. Gaskin ed. Proceedings of the 8th International Symposium on Adjuvant for Agrochemicals; Publisher: International Society for Agrochemical Adjuvant (ISAA), Columbus, Ohio, USA). The formulations listed in table 5 were diluted with water to 0.8% and 1.2% and the dynamic surface tension was measured.

TABLE 5
Dynamic surface tension
Dynamic surface tension at 200 ms [mN/m]

| Formulation | Amount 0.8 wt % | Amount 1.2 wt % |
|---|---|---|
| A1 (Reference) | 39.8 | 37.6 |
| A5 (Invention) | 42.2 | 33.7 |
| A6 (Invention) | 53.3 | 48.4 |
| A8 (Invention) | 54.5 | 48.3 |
| A10 (Invention) | 54.7 | 48.5 |
| A12 (Invention) | 54.9 | 48.8 |
| A13 (Invention) | 45.5 | 39.3 |
| A14 (Invention) | 49.2 | 42.7 |
| B1 (noninventive) | 42.3 | 39.5 |
| B6 (Invention) | 52.2 | 45.4 |
| B7 (Invention) | 51.8 | 45.3 |
| C3 (Invention) | 42.2 | 36.0 |
| C5 (Invention) | 51.8 | 47.2 |
| C7 (Invention) | 52.9 | 46.5 |

The inventive compositions, even at low dosage, exhibit dynamic surface tensions <55 mN/m (at 200 ms), suggesting outstanding sticking properties on the leaf surface.

### Example 7

### Coverage

Formulations A1, A5 and A6 as per table 1 were diluted with water to 1.2%, and 0.1% of fluorescent tracer (Blankophor BBU) was added. The spray mixture is applied at a typical water application rate of 100-120 l/ha in a spraying cabin, to bamboo and, respectively, to wheat leaves, each of which are difficult to wet, using a flat-jet nozzle (Teejet XR11002, 3 bar). The degree of wetting of the leaves after application is studied under a UV lamp and recorded photographically. The degree of wetting was determined via phase analysis using image analysis software. The degree of wetting is determined as percent of the wetted area in comparison to the total leaf surface.

TABLE 6
Wetting on different leaf surfaces

| | Degree of wetting [%] | |
|---|---|---|
| Formulation | Bamboo | Wheat |
| Water | 1.94 | 0.67 |
| A1 (Reference) | 44.95 | 16.08 |
| A5 (Invention) | 79.01 | 43.13 |
| A6 (Invention) | 37.04 | 22.33 |

### Example 8

### Biological Activity of Aqueous Glufosinate Formulations

Use with Glufosinate for Weed Control

Formulations A5 and A6 as per table 1 were diluted with water to give a water application rate of 120-400 l/ha at a typical application rate for glufosinate (300-1000 g/ha) on application to noncrop land containing a spectrum of mono-and dicotyledonous weed plants which had emerged under natural conditions. Evaluation of the effect after four weeks revealed that the green parts of the weed plants had died and therefore that control of the weed plants was effective. For example, formulations A5 and A6 from table 1, in comparison to the commercial formulation A1, with the same glufosinate application rate, with regard to biological effect, gave comparably good results in the control of mono- and dicotyledonous weed plants.

1. A composition comprising
a) glufosinate or a water-soluble salt thereof,
c) at least one or N-alkylglucamide of the formula (l) 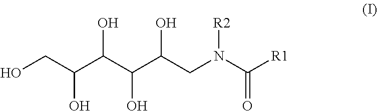
where
R1 is a linear or branched alkyl group having 5 to 9 carbon atoms, and
R2 is an alkyl group having 1 to 3 carbon atoms,
d) a di-or trihydric alcohol cosolvent, and
h) water.

2. The composition as claimed in claim 1, further comprising at least one of the following constituents:
b) at least one further active agrochemical ingredient, and/or
e) at least one nitrogen-containing salt and/or urea, and/or
f) at least one surfactant, and/or
g) at least one other customary formulating assistant.

3. The composition as claimed in claim 1, wherein a) is a water-soluble salt of glufosinate.

4. The composition as claimed in claim 3, wherein a) is glufosinate-ammonium.

5. The composition as claimed in claim 2, wherein the composition comprises glufosinate or a water-soluble salt thereof of component a) and at least one further active agrochemical ingredient of component b).

6. The composition as claimed in claim 5, wherein the at least one further active agrochemical ingredient of component b) is a water-soluble salt of a pesticide.

7. The composition as claimed in claim 2, wherein the at least one further active agrochemical ingredient of component b) is an insecticide or growth regulator.

8. The composition as claimed in claim 2, wherein component a) is a water-soluble salt of glufosinate and component b) is at least one water-soluble auxin.

9. The composition as claimed in claim 8, wherein component a) is glufosinate-ammonium and component b) comprises water-soluble salts of dicamba.

10. The composition as claimed in claim 1, comprising glufosinate or a water-soluble salt thereof of component a) in an amount of more than 10 wt %.

11. The composition as claimed in claim 1, comprising 18 to 40 wt %, glufosinate or a water-soluble salt thereof of component a), and no further active agrochemical ingredients.

12. The composition as claimed in claim 2, comprising 15 to 30 wt % glufosinate or a water-soluble salt thereof of component a) and 15 to 30 wt % of at least one further active agrochemical ingredient of component b).

13. The composition as claimed in claim 1, wherein it comprises as component c) a mixture of octanoyl-N-methylglucamide (wherein R1=C₇ alkyl, R2=methyl) and decanoyl-N-methylglucamide (wherein R1=C₉ alkyl, R2=methyl).

14. The composition as claimed in claim 1, wherein it comprises as component d) propylene glycol, glycerol or polyethylene glycols, polypropylene glycols and/or mixed polyalkylene glycols (PAGs) or combinations thereof.

15. The composition as claimed in claim 2, wherein it comprises as component e) ammonium salts and/or urea.

16. The composition as claimed in claim 2, wherein is a concentrate formulation which contains
a) 1 to 40 wt %, glufosinate or a water-soluble salt thereof,
b) 0 to 40 wt %, of at least one further active agrochemical ingredient,
c) 0.1 to 97 wt %, of at least one alkylglucamide of the formula (I),
d) 1 to 30 wt %, of at least one trihydric alcohol cosolvent,
e) 0 to 25 wt %, of at least one nitrogen-containing salt and/or urea,
f) 0 to 25 wt %, of at least one surfactant,
g) 0 to 50 wt %, of at least one further customary formulating assistant, and
h) 0.01 to 95 wt %, of water.

17. The composition as claimed in claim 2, wherein it takes the form of a spray mixture and comprises
0.001 to 10 wt %, of glufosinate or a water-soluble salt thereof,
0.001 to 10 wt %, of at least one further water-soluble active agrochemical ingredient of component b).

18. A method for producing a composition comprising
a) glufosinate or a water-soluble salt thereof,
c) at least one N-alkylglucamide of the formula (I) 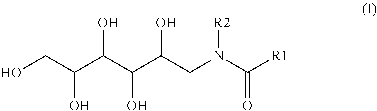
where
R1 is a linear or branched alkyl group having 5 to 9 carbon atoms, and
R2 is an alkyl group having 1 to 3 carbon atoms,
d) a di-or trihydric alcohol cosolvent, and
h) water, comprising the step of mixing components a) c), d), and h) and optionally further components.

19. A method for accelerating the uptake of glufosinate into a plant, comprising the step of contacting the plant with a composition comprising
a) glufosinate or a water-soluble salt thereof,
c) at least one N-alkylglucamide of the formula (I) 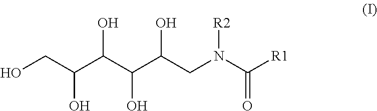
where
R1 is a linear or branched alkyl group having 5 to 9 carbon atoms, and
R2 is an alkyl group having 1 to 3 carbon atoms,
d) a di-or trihydric alcohol cosolvent, and
h) water.

20. A method for reducing the foaming tendency of compositions comprising glufosinate as active agrochemical ingredient, comprising the step of adding at least one alkylglucamides of the formula (I) 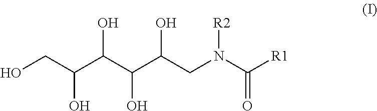
where
R1 is a linear or branched alkyl group having 5 to 9 carbon atoms, and
R2 is an alkyl group having 1 to 3 carbon atoms, to the composition.

21. A method for checking and/or controlling weeds, fungal diseases or insect infestation in plants comprising the step of contacting the weeds, fungal diseases or plants with a composition comprising
a) glufosinate or a water-soluble salt thereof,
c) at least one N-alkylglucamide of the formula (I) 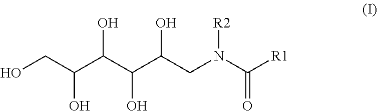
where
R1 is a linear or branched alkyl group having 5 to 9 carbon atoms, and
R2 is an alkyl group having 1 to 3 carbon atoms,
d) a di-or trihydric alcohol cosolvent, and
h) water.
